(19) United States
(12) Patent Application Publication
(10) Pub. No.: US 2007/0083531 A1
(43) Pub. Date: Apr. 12, 2007

(54) Data storage method and apparatus utilizing evolution and hashing

(76) Inventor: Daniar Hussain, New York, NY (US)

Correspondence Address: Daniar Hussain, 211 W 56th Street, Apt. 10M, New York, NY, 10019, US

(21) Appl. No.: 11/248,115

(22) Filed: Oct. 12, 2005

(51) Int. Cl. G06F 7/00

(52) U.S. Cl. 707/100

(57) ABSTRACT

Hashing functions have many practical applications in data storage and retrieval. Perfect hashing functions are extremely difficult to find, especially if the data set is large and without large-scale structure. There are great rewards for finding good hashing functions, considering the savings in computational time such functions provide, and much effort has been expended in this search. This in mind, we present a strong competitive evolutionary method to locate efficient hashing functions for specific data sets by sampling and evolving from the set of polynomials over the ring of integers mod n. We find favorable results that seem to indicate the power and usefulness of evolutionary methods in this search. Polynomials thus generated are found to have consistently better collision frequencies than other hashing methods. This results in a reduction in average number of array probes per data element hashed by a factor of two. Presented herein is an evolutionary algorithm to locate efficient hashing functions for specific data sets. Polynomials are used to investigate and evaluate various evolutionary strategies. Populations of random polynomials are generated, and then selection and mutation serve to eliminate unfit polynomials. The results are favorable and indicate the power and usefulness of evolutionary methods in hashing. The average number of collisions using the algorithm presented herein is about one-half of the number of collisions using other hashing methods. Efficient methods of data storage and retrieval are essential to today's information economy. Despite the cur-rent obstacles to creating efficient hashing functions, hashing is widely used due to its efficient data access. This study investigates the feasibility of overcoming such obstacles through the application of Darwin's ideas by modeling the basic principles of biological evolution in a computer. Polynomials over Zn are the evolutionary units and it is believed that competition and selection based on performance would locate polynomials that make efficient hashing functions.

### BACKGROUND OF THE INVENTION

1. Field of the Invention

This invention relates to methods of data storage, particularly to systems utilizing hash tables to store data. The invention is directed to locating perfect and efficient hashing functions for a given data set. The instant invention also relates to evolutionary computation and genetic algorithms.

2. Description of the Related Art

Efficient methods of data storage and retrieval are extremely important in today's information world. Computers are indispensable tools for mass data organization and distribution. Over the last three decades, many data organization techniques have been developed and they range in efficiency and application. The basis of many such techniques is the array, and a recently developed technique called hashing uses this basic data structure in an untraditional manner. The distinguishing feature of hashing is that data is accessed non-sequentially, in contrast to other techniques which require sequential data access. There are many real-world applications of this invention. Everything in today's economy depends on fast retrieval of large amounts of data.

There are many advantages to hashing over the numerous other data organizational methods, such as sorting and searching, binary trees, etc. A hashing table with a good hashing function can usually guarantee O(1) insertions and retrievals, regardless of the number of data items. If data access is frequent and ordered data is not important, hashing is highly favorable to sequential or linked-list data storage with O(n) additions and deletions and even to binary trees, with O(log n) additions and deletions in the average case (see Table 1). Many important applications of hashing functions are explored in the literature: see Pothering et al.: “Density-dependent search techniques,” Introduction to data structures and algorithm analysis with C++: 505-533, 1995; and Tenenbaum et al.: “Hashing,” Data structures using C: 454-502, 1990; both incorporated herein by reference. Computations as diverse as string search and airline ticket reservations can be handled efficiently with hashing.

TABLE 1
Comparison of the computational complexity
of various data storage methods

| | | | | Binary |
|---|---|---|---|---|
| | | Unordered | Ordered | Search |
| Operation | Hash Table | List | List | Tree |
| Initialize | O(n) + | O(n) | O(n*log n) | O(n*log n) |
| | preprocessing | | | |
| Add Item | O(l) | O(l) | O(n) | O(log n) |
| Remove Item | O(l) | O(n) | O(n) | O(log n) |
| Search Item | O(l) | O(n) | O(log n) | O(log n) |

n = number of data elements

The value of a hashing table, however, is only as good as its associated hashing function. Not all relations qualify as hashing functions; a hashing function must take inputs from some set S of data elements and map them to the set of integers modulus n (Zₙ), where n is the size of the hash table (see FIG. 1). To guarantee operation in O(1) time, the hashing function must have an efficient way to map elements in the data set to storage addresses. This means that the function itself must be easy to compute and must spread the data uniformly over the possible range of storage addresses. Each storage address in the range should be equally likely to receive any one of the data elements.

Unlike with other data storage techniques, there is some possibility of data conflict. This can happen if the hashing function maps two different elements in S to the same integer in Zₙ. This is called data collision and in general is unavoidable. We define collision frequency as the number of collisions divided by the number of data items being hashed. If a function has no collisions when hashing a particular data set, it is called a perfect hashing function. Although in theory perfect hashing functions exist for any data set, in practice they are in extremely difficult to find and very cumbersome to work with. Furthermore, they are highly restrictive and are efficient only for small data sets.

There are several strategies to cope with data collision. The most common such method, called linear rehash, is to place the data item into the next available slot in the array. A problem, called primary clustering, can arise, causing data to clump as the density of the data increases A second possible solution, called double hashing, is to rehash the data item with a different hashing function. The instant invention uses both techniques.

Due to the nature of hashing, performance of the hash table depends on the load factor, or density of the data being hashed. One must be willing to compromise space efficiency for time efficiency. For this reason, it is important to compare hashing functions under very similar, if not identical situations, where the load factor is the same in each case. It is also important to observe how a hashing function's behavior degrades with larger load factors. This can be an important criterion in cases where storage is expensive and large load factors occur often.

Many hashing schemes have been discussed in the literature. Foremost among them include folding, digit extraction, division-remainder, and pseudo-random number generators (see Pothering 1995). Most of these techniques have to be hand-tailored in each particular situation for even moderate efficiency. They are often too cumbersome to automate and require many hours of careful study by an experienced hashing expert.

A number of perfect hashing techniques have also been examined in the literature. Sprugnoli has developed quotient reduction perfect hashing functions, along with a deterministic algorithm to determine various parameters within the functions (see Sprugnoli: “Perfect hashing functions: a single probe retrieving method for static sets,” Comm. ACM: 20 (11), November 1977; herein incorporated by reference). Unfortunately, this algorithm is O(n³), with a large constant of proportionality, which makes it impractical even for very small data sets. Sprugnoli presents another group of hashing functions, called remainder reduction perfect hash functions, along with another algorithm to determine various free parameters. However, this algorithm does not guarantee that a perfect hashing function can be found in reasonable time for high load factors.

Jaeschke presents a method for generating minimal perfect hash functions using a technique called reciprocal hashing (see Jaeschke: “Reciprocal hashing: a method for generating minimal perfect hashing functions,” Comm. ACM: 24 (12), December 1981; herein incorporated by reference). For small values of n (small table sizes), approximately 1.82ⁿ functions are examined by his algorithm, which is tolerable for n≦20 (Tenenbaum 1990). This is clearly impractical for situations that require hundreds or even thousands of data entries.

Chang presents an order-preserving perfect hashing function that depends on the existence of a prime number function (see Chang: “The study of an ordered minimal perfect hashing scheme,” Comm. ACM: 27 (4), April 1984; herein incorporated by reference). Unfortunately, prime number functions are often very difficult to find, which makes his techniques unpractical. Carter et al. and Sarwate have explored the concept of universal classes of hash functions (see Carter et al.: “Universal classes of hash functions,” J. Comp. Sys. Sci., 18: 143-154, 1979; and Sarwate: “A note on universal classes of hash functions,” Inform. Proc. Letters, 10 (1): 41-45, Feb. 1980; both incorporated herein by reference). This work is largely theoretical, however, and the classes are complicated to compute, and therefore not practically useful.

Hashing functions can often be tailored to specific data sets. However, it may take a human several weeks of careful study to handcraft a hash function for one specific application. For each new application that emerges, a new hash function has to be created. Several perfect hashing schemes have been developed to deal with this problem. These functions contain free parameters that are automatically adjusted by a deterministic algorithm to configure the function to the data. As we will see in the next section, all of these hashing schemes are fraught with difficulties, including severe limitations on the maximum number of data elements that can be hashed efficiently.

The following definitions will be useful in understanding the spirit and scope of the present invention. Collision: a collision occurs whenever two different data elements are hashed to the same storage address; Perfect hashing function: given a data set, such a function hashes the data with no collisions; Density: the ratio of the number of data elements to the size of the hash table; Psuedo-random number generator: an algorithm, which when given an input seed, produces a sequence of outputs that pass the statistical tests of randomness; Hashing function: A hashing function maps elements from some data set S to the set of integers modulus n (Zₙ), where n is the size of the hash table (see FIG. 1). Ideally, the hashing function should be easy to compute and should spread the data uniformly over the range of storage addresses.

### SUMMARY OF THE INVENTION

In view of the foregoing, it is an object of the present invention to automatically tailor hashing functions to a specific data set.

Hashing has been a successful method by which data can be organized and stored. But hashing has often required many hours of human intervention in order to improve efficiency which has made its use sometimes unpractical. This work solves this difficult hurdle by providing an efficient method by which hashing functions can be found for any particular data set. Furthermore, the technique is fully automated, which means that almost no human intervention is required.

The polynomial is one of the best candidates for a hashing scheme; its arbitrarily many coefficients can be modified as free parameters. Polynomials as hashing functions have not been fully explored in the literature because the many free coefficients create a large search space that cannot be efficiently examined using traditional deterministic algorithms. An object of the invention is an evolutionary technique to vastly improve the search speed, making polynomials as hashing functions accessible for the first time.

Evolution can be treated as an abstract process that operates whenever certain conditions are met. Because of the usefulness of the biological model, we have borrowed all of the standard biological definitions; we have simply expanded the scope of their applicability. We use terms like “survive,” “mutation,” “competition,” “environment,” etc. in an intuitive, yet precise way. They are meant to convey in a metaphorical manner the essential concepts that are difficult to express without using the language of biology.

We have abstracted away three important conditions from the specifics of natural organism evolution that we believe are essential ingredients for evolution.
1. Condition of Variation—there must exist internal variation within the population, in addition to a constant source of variation (we call this source mutation).
2. Condition of Competition—some resource must be in limiting quantity that is essential to survival; the extent to which members succeed in harnessing this resource determines their survival.
3. Condition of Inheritance—there must be some connection or linkage between organisms in different generations; in biology these are usually chromosomes.

In our model, the hashing function is viewed as a “creature” that lives in the data set, which plays a role analogous to that of the environment in natural evolution. The hash function has to “adapt” to the environment, and successful adaptation means that a hash function has a low number of collisions hashing a particular data set. We consider the collision frequency the limiting resource—polynomials that have the lowest collision frequency are considered successful in their environment.

We now define our creatures, the polynomials: Let p be defined as a single-variable polynomial over Zₙ (the integers mod n). We sayp is a random polynomial if its degree is a discrete random variable sampled from {0,1, . . . , max_degree}, and its coefficients are continuous random variables sampled from the interval [0, max_coeff]. (See Sobol: “Random variables,” Monte Carlo: an introduction: 1-11, 1995, herein incorporated by reference, for the definition of a random variable.) The hash value of a data element is the value of the polynomial if it is applied to the data element. Note that this implies that all of the data must be representable by real numbers. If the data is not already represented as real number, there are many simple methods by which to convert the data into real numbers (see Pothering 1995).

The present invention is an evolutionary algorithm to find a polynomial that is well suited as a hashing function to a particular data set. The general outline of the algorithm follows:
1. Generate random set of polynomials. These represent the initial population of polynomials, with intrinsic variability.
2. Each polynomial in the set is used as a hashing function to hash all of the data. The number of collisions is recorded and the polynomials are ranked based on their performance.
3. The polynomials with the lowest 20% of collision frequencies are considered “successful” and saved for the next round. The polynomials with the highest 20% of collisions are removed from the population (many collisions when hashing data), and replaced with new random polynomials. The middle 60% of the polynomials are kept for the next round, but some of their coefficients are randomized (mutated). This step is repeated a desired number of times.
4. Polynomials may be allowed to partner together based on several criteria. The polynomials may be partnered with other polynomials with collision frequencies in the same range. These pairs are then allowed to act as double hashing functions for the data set.

According to the foregoing, the present invention is achieved through the following method and apparatus of data storage and retrieval. A method of data storage comprising the steps of: (i) creating an empty hash table; (ii) generating a plurality of functions randomly; (iii) hashing the data using each one of the plurality of functions; (iv) recording a number of collisions for each one of the plurality of functions; (v) ranking the plurality of functions based on the number of collisions; (vi) saving the plurality functions within a first range of collisions; (vii) modifying the functions within a second range of collisions and saving the plurality functions within the second range of collisions; (viii) deleting the plurality functions within a third range of collisions and generating new random functions equal to the number deleted; and (ix) selecting a function with a lowest number of collisions as a hashing function for the hash table; where the first range of collisions is lower than the second range of collisions, which is lower than the third range of collisions.

The method can further comprise: (a) selecting a target collision frequency and a maximum number of iterations; and (b) repeating steps (ii) to (viii) until either the target collision frequency has been reached, or the maximum number of iterations has been exceeded.

The following modifications to the method are possible. Step (vii) can further comprise randomly mutating the plurality of functions within the second range of collisions. Step (vii) can alternatively further comprise pairing polynomials within the second range of collisions and using the pairs as double hashing functions in the hash table.

The method can further comprise: storing a data item by using the function selected in step (ix) to hash the data item; retrieving a data item by using the function selected in step (ix) to hash the data item; testing for presence of a data item by using the function selected in step (ix) to hash the data item.

The plurality of hashing functions can be polynomials. Alternatively, the plurality of hashing functions can be Fourier series.

A data storage apparatus for storing and retrieving data, comprising: a hash table; a hash function selected from a plurality of functions with a lowest number of collisions; a random function generator to generate said plurality of functions; logic means to hash said data using each one of the plurality of functions; recording means to record a number of collisions for each one of the plurality of functions; ranking means to rank the plurality of functions based on the number of collisions; storage means to store functions; and selection means to select a function from the plurality of functions with the lowest number of collisions; where a plurality of functions within a second range of collisions are modified, where a plurality of functions within a third range of collisions are deleted and new random functions equal to the number deleted are randomly generated by the random function generator, and where the first range of collisions is lower than the second range of collisions, which is lower than the third range of collisions.

As one of ordinary skill in the art would readily appreciate, the same modifications described above with regard to the method can be equally applied to the apparatus.

### BRIEF DESCRIPTION OF THE DRAWINGS

The above and other objects, features, and advantages of the present invention will be apparent from the following detailed description of illustrative embodiments which is to be read in connection with the accompanying drawings, in which:

FIG. 1 is a schematic illustration of a hashing function;

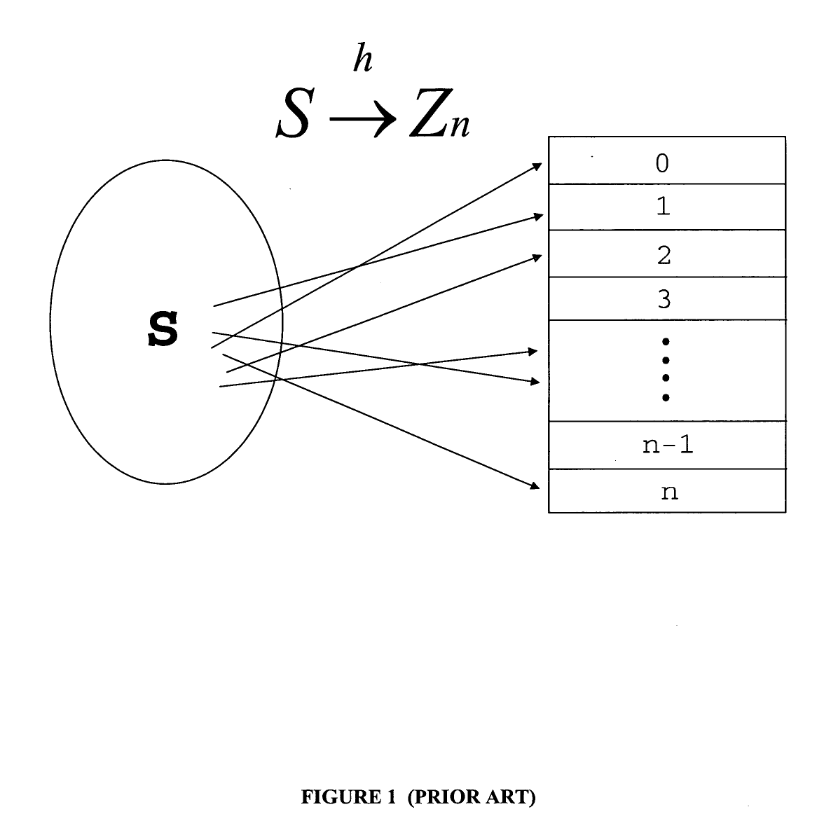

FIG. 2 illustrates hashing efficiency of the present invention when testing for a data item that is present in random data;

FIG. 3 illustrates hashing efficiency of the present invention when testing for a data item that is absent in random data;

FIG. 4 illustrates hashing efficiency of the present invention when testing for a data item that is present in structured data;

FIG. 5 is a graph of the mean collision frequency of the functions versus time—the evolution of the hashing functions leads to a decrease in the mean collision frequency as time passes;

FIG. 6 is a graph of the standard deviation of the collision frequency of the functions versus time—the evolution of the hashing functions leads to a decrease in the standard deviation of the collision frequency as time passes;

FIG. 7 is a graph of a situation with punctuated equilibrium; and

FIG. 8 is a graph of a situation where conditions of the data set are changed or varied at preset times.

### DETAILED DESCRIPTION OF THE PREFERRED EMBODIMENTS

### First Embodiment of the Invention

The pseudocode in Table 2 outlines the invention in greater detail. Note that the most expensive computation (marked with a *) is calculating the number of collisions for each polynomials, which involves rehashing all of the data. Note that this step has to be performed O(num_iter*num_pop) times. But as will become apparent later, this non-deterministic method has a fast rate of convergence because it utilizes non-traditional techniques.

TABLE 2
Outline of the invention

void evolvePoly( ) {

| | |
|---|---|
| polynomial<int> pop[num_pop]; | //population to evolve |
| for( int i=0; i<num_iter; i++ ) | // for each iteration |

| | |
|---|---|
| for( int j=0; j<num_pop; j++ ) | // for each polynomial |

| | | |
|---|---|---|
| (*) | pop[j].col = calc_col(pop[j]); | // calculate collisions |

| | |
|---|---|
| sort( pop, pop.col ); | // sort polynomials based on collisions |
| mutate_poly( pop ); | // mutates the middle 60% of polynomials |
| replace_poly( pop ); | //replaces bottom 20% of polynomials |

}

A similar algorithm was used for evolving two “mated” polynomials; the only difference being that the polynomials were paired right after the sort step was performed.

Care was taken to use two separate random number generators; one for generation of the data set and one for the polynomial coefficients. If the same random number generator is used in both cases, results may be biased by the deterministic nature of the random number algorithms. Patterns in the random numbers may correlate the data and polynomial coefficients in unpredictable ways. Experimentation determined that best results are achieved by using two different random number generators. We experimented with the random number generator that comes supplied with Microsoft Visual Studio (2000), one written by Matsumoto and Nishimura, and a third one written by Cheng (1978). (See Cheng: “Generating beta variatew with nonintegral shape parameters,” Comm. ACM, 21: 317-322, 1978; herein incorporated by reference.)

In addition to the random number generators, there should be a reliable source of random number seeds. Using the system clock, as is popular in many other settings, does not work well in this situation. A peculiar feature of some random number generators is that similar seeds produce similar sequences of random numbers. This is highly undesirable, especially if many experiments are performed close in time. We found that a natural source of random numbers, such as atmospheric noise or particle decay, make excellent seeds. We experimented with several such online sources (See Walker: HotBits http://www.fourmilab.ch/hotbits/, 1999; incorporated herein by reference.), and achieved substantially better results as compared with using the system clock as a seed. We wrote a seeder class to retrieve the next seed in the seeder file, which is downloaded for each run from one of the online sources. The header prototypes for this class can be seen in Table 9.

We compared two different evolutionary strategies with two common hashing techniques (see Table 4). The first strategy involved evolving a single polynomial to a data set using the method described above. If a data collision occurred, linear rehash was applied to the data until each data item was placed into the array. The second strategy that was investigated was double hashing—two polynomials were “mated” that had performed well in the environment. These two polynomials were used as double hashing functions. If there was a collision using the first polynomial, the data was rehashed using the second polynomial. Any collisions that remained were rehashed using the linear technique.

Two different types of data sets were tested—a random data set and a structured data set. The random data set was regenerated using a random number generator for each run of the algorithm, and the structured data was generated using a predetermined formula. The formula used was an algebraic combination of several elementary functions. This was done to investigate the affects of structure on the evolutionary methods. Non-random structure in the data can lead to clustering that is more severe than clustering in random data.

The two hashing techniques that the evolutionary strategies were compared against were pseudo-random number generator and simple division-remainder. In the first method, the data was used as a seed to the random number generator, and the next random number in the sequences was used as the hash value. In the second case, the data was simply divided by the size of the hash table, and the remainder was used as the hash value.

Some important constants that were used in the implementation of the algorithm are listed in Table 3.

TABLE 3
Constants used in implementation

| Constant | Value |
|---|---|
| Table size | 997 |
| Population size | 50 |
| Number of iterations | 1000 |
| Maximum degree of polynomials | 9 |

Table 9 contains the header prototypes for the hashing table class and the seeder class.

TABLE 4
Comparison of various hashing methods of the prior art with the present invention.

| | | Pseudorandom | | | |
|---|---|---|---|---|---|
| | | number | Linear/quadratic | Perfect hash | Polynomial |
| | Modulus n | generator | rehash | schemes | Evolution |
| Equation | h(x) = x mod n | h(x) = rand(x) | h(x) = h'(x) + 1 | Various | h(x) = a₀+ a₁x + |
| | | | (or i²) | | a₂x² + . . . + |
| | | | | | aₙxⁿ |
| Advantages | Simple to | Reasonable | Simple to | Zero collisions; | Low collision |
| | compute | efficiency for | compute; | relatively small | frequency |
| | | minimal | guarantees | computational | |
| | | computational | placement of | cost for | |
| | | cost; readily | data | insertion and | |
| | | available and | | retrieval | |
| | | large variety | | | |
| Disadvantages | Frequent | Inability to | Primary and | Large | Evolution |
| | collisions | tailor to | secondary | preprocessing | requires time- |
| | decrease | specific data | clustering | makes method | intensive |
| | efficiency | sets | results in | impractical for | preprocessing |
| | | | inefficiency | medium to | |
| | | | with large load | large data sets | |
| | | | factors | | |
| Comments | Simplest | Many \ | Most commonly | Mostly of only | Excellent for |
| | strategy | algorithms | used rehash | theoretical | relatively static |
| | | already | scheme | interest | data sets |
| | | available | | | |

The evolutionary strategy has proven to be very successful in finding polynomials with efficient collision frequencies. The evolved polynomials have consistently better collision frequencies than the other two hashing techniques that were studied. The success of the evolved polynomials is more dramatic for larger data density. This indicates that the evolved polynomials spread the data out more uniformly along the array than the other hashing strategies tested. This is important because it reduces the amount of data clustering, which is in general the largest performance deterioration when using hashing data organization.

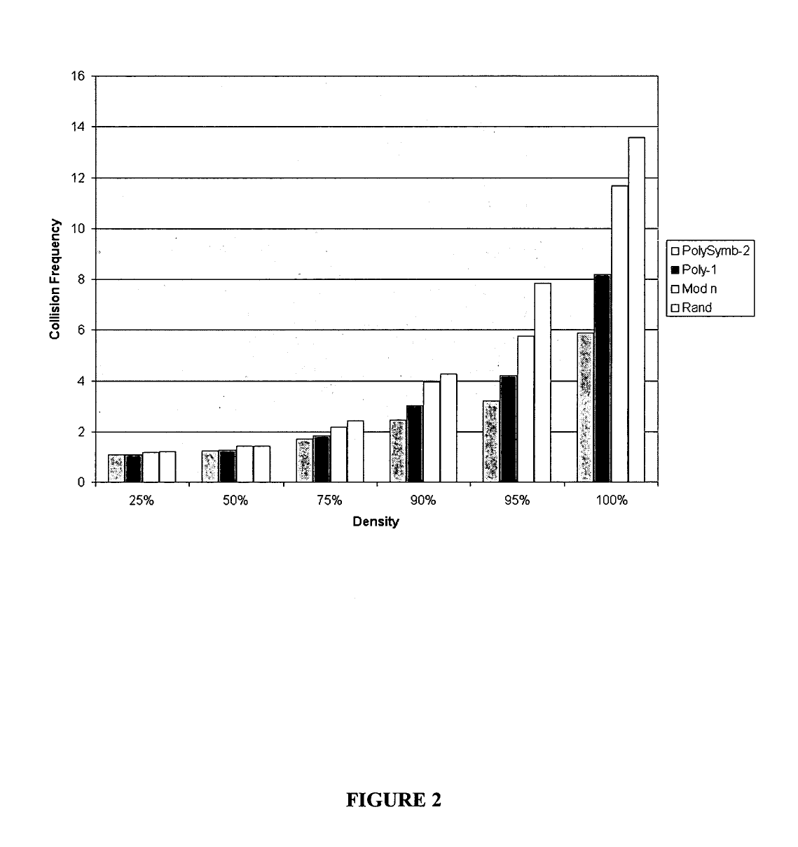

Table 5 and FIG. 2 reports our results hashing random data with the pseudo-random number generator (rand), simple division-remainder (mod n), a single evolved polynomial (Poly-1), and two polynomials (PolySymb-2) evolved as “partners,” as described earlier. The values reported are the average number of accesses (probes) to the array that are required to determine the location of an element that is already in the hash table. This is referred to as “successful” hash-table access by Tenenbaum et al. (1990).

TABLE 5
Average number of probes per successful
hash-table access for random data

| Density | Rand | Mod n | Poly-1 | PolySymb-2 |
|---|---|---|---|---|
| 25% | 1.20 | 1.17 | 1.076 | 1.084 |
| 50% | 1.434 | 1.422 | 1.284 | 1.246 |
| 75% | 2.42 | 2.19 | 1.85 | 1.70 |
| 90% | 4.26 | 3.94 | 3.02 | 2.45 |
| 95% | 7.84 | 5.75 | 4.19 | 3.20 |
| 100% | 13.56 | 11.67 | 8.19 | 5.87 |

It is clear from the results in Table 5 and FIG. 2 that the evolutionary algorithm is extremely successful in locating polynomials with low collision ratings. As expected, performance degrades significantly with increased density—this is true for all hashing functions, and the method presented here is no exception. The evolved polynomials show significantly better performance (measured by the collision frequency) than the other two common hashing methods—random number generator and modulus n. Two polynomials evolved “symbiotically” demonstrate even better performance—with an average collision frequency about one-half or lower as compared to the other two hash methods.

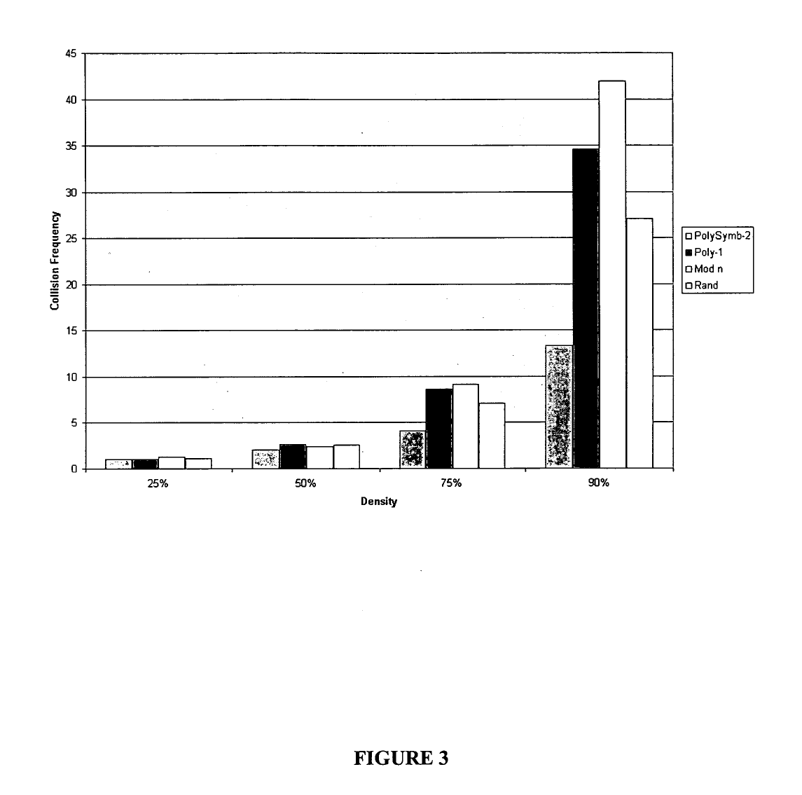

Naturally, more hash table probes are required to determine if a data element is not in the array. This situation becomes more dramatic as the density of the data increases. The reason for this is simple—when the hash table is nearly full, the hashing algorithm needs to consider almost all of the hash entries until it can determine that a particular data element is not present. This condition is referred to as “unsuccessful” hash table access by Tenenbaum et al. (1990), and our average values are reported in Table 6 and FIG. 3.

TABLE 6
Average number of probes per unsuccessful
hash-table access for random data

| Density | Rand | Mod n | Poly-1 | PolySymb-2 |
|---|---|---|---|---|
| 25% | 1.136 | 1.3 | 1.06 | 1.064 |
| 50% | 2.574 | 2.422 | 2.642 | 2.074 |
| 75% | 7.05 | 9.15 | 8.60 | 4.12 |
| 90% | 27.11 | 41.93 | 34.56 | 13.34 |
| 95% | 66.64 | 79.00 | 182. | 38.6 |
| 100% | 387. | 281. | 468. | 113. |

Our results with the pseudo-random number generator and simple division-remainder are consistent and comparable to the results of Tenenbaum et al. (1990). He reports the average number of probes for both strategies for both successful and unsuccessful retrieval. This gives confidence to the accuracy and correctness of our hashing code.

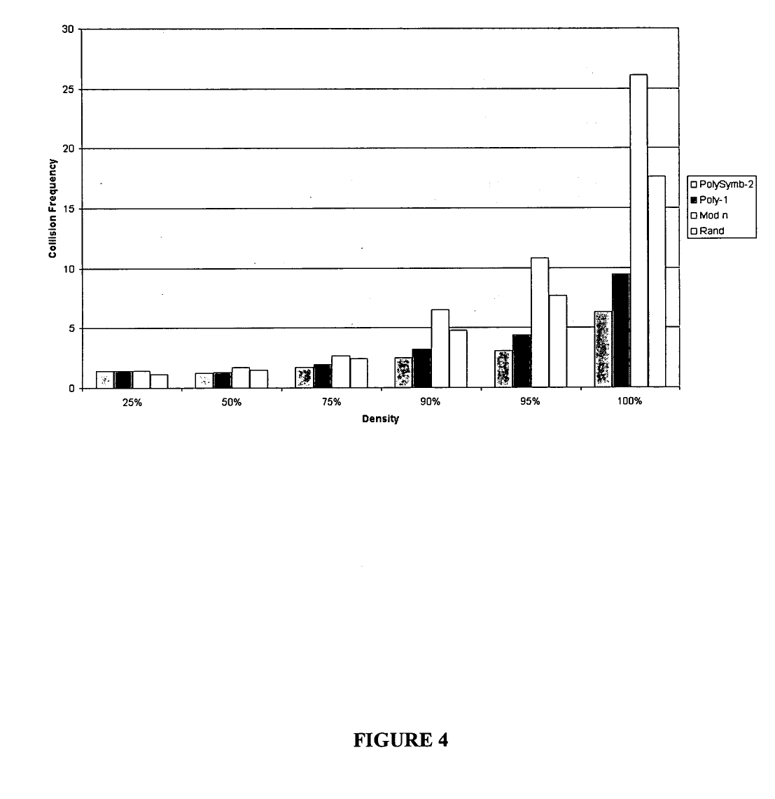

In general, in real-world applications, the data will not be random, but will have some sort of internal structure or patterns. The various hashing techniques known to date can not adjust themselves to the particular patterns in the data. We found that evolutionary methods can adapt polynomials to the structure that may appear in a data set. We used an algebraic combination of various elementary functions to create the data to be hashed, and then compared the success of the two evolutionary strategies with the two other common hashing methods studied previously. Our results for both the average successful and unsuccessful probes are reported in Table 7 & FIG. 4, and Table 8, respectively.

TABLE 7
Average number of probes per successful
hash-table access for structured data

| Density | Rand | Mod n | Poly-1 | PolySymb-2 |
|---|---|---|---|---|
| 25% | 1.128 | 1.412 | 1.388 | 1.436 |
| 50% | 1.462 | 1.696 | 1.306 | 1.244 |
| 75% | 2.43 | 2.68 | 1.94 | 1.70 |
| 90% | 4.77 | 6.48 | 3.19 | 2.47 |
| 95% | 7.68 | 10.8 | 4.39 | 3.07 |
| 100% | 17.6 | 26.1 | 9.45 | 6.34 |

TABLE 8
Average number of probes per unsuccessful
hash-table access for structured data

| Density | Rand | Mod n | Poly-1 | PolySymb-2 |
|---|---|---|---|---|
| 25% | 7.11 | 11.6 | 7.84 | 4.14 |
| 50% | 14.1 | 21.6 | 8.56 | 5.15 |
| 75% | 32.8 | 56.3 | 29.6 | 15.1 |
| 90% | 90.8 | 171. | 88.1 | 26.8 |
| 95% | — | — | — | — |

Note that performance degrades with all four hashing functions when using non-random data as compared to random data; but this is expected. Random data is itself already uniform, thus resulting in less hashing collisions. With non-random data, however, it is the task of the hashing function to distribute the data evenly throughout the hash table. Notice that as the density of the data becomes large and close to 100%, the performance of the pseudo-random number generator as well as simple division-remainder degrades severely. However, the single evolved polynomial (Poly-1) is much more resistant to degrading efficiency. And the polynomial-partners evolved as double-hashing functions (PolySymb-2) suffers only mild performance degradation. This is important because in real applications, where data has internal structure, evolutionary strategies will be largely superior to other hashing methods known to date.

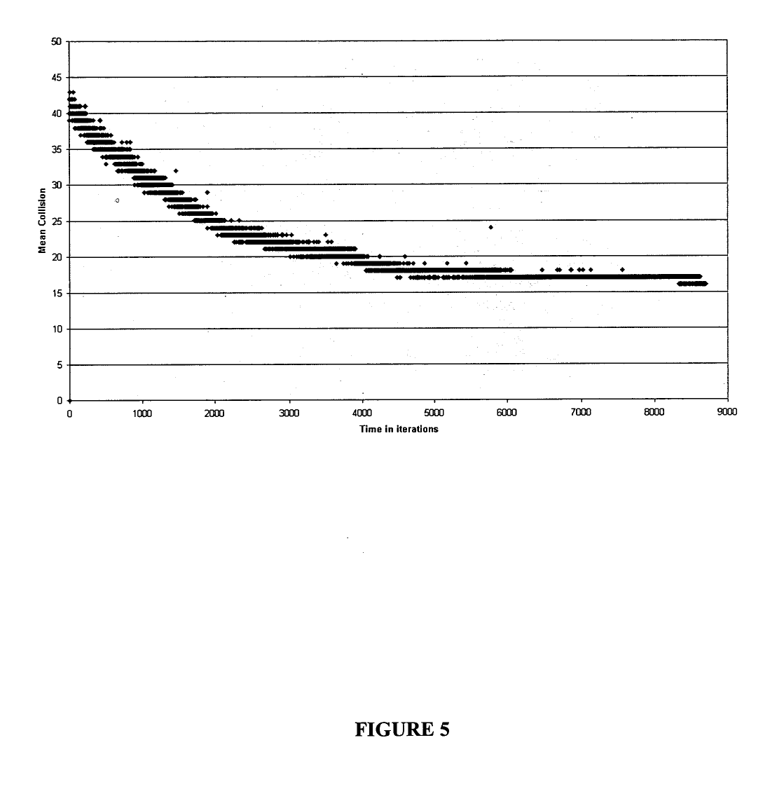

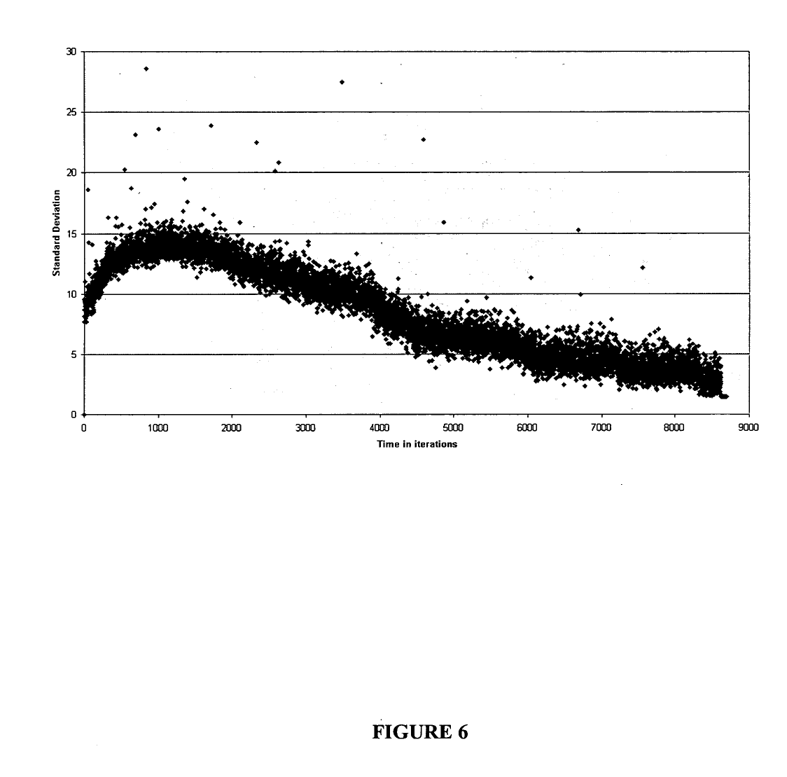

FIG. 5 shows that as evolution progresses in time (x-axis), the mean collision frequency decreases. The mean collision frequency then saturates at a limiting value as time tends to infinity. FIG. 6 shows that as evolution begins, the standard deviation of the collision frequency begins to increase, signifying that the variability within the population is initially increasing. After selective pressures have persisted for a certain period of time, the standard deviation begins to decrease, signifying that the mean collision frequency is converging on a limiting value. Note that the standard deviation approaches a small, but non-zero limiting value, signifying that the variability in the population approaches a small, but non-zero, value.

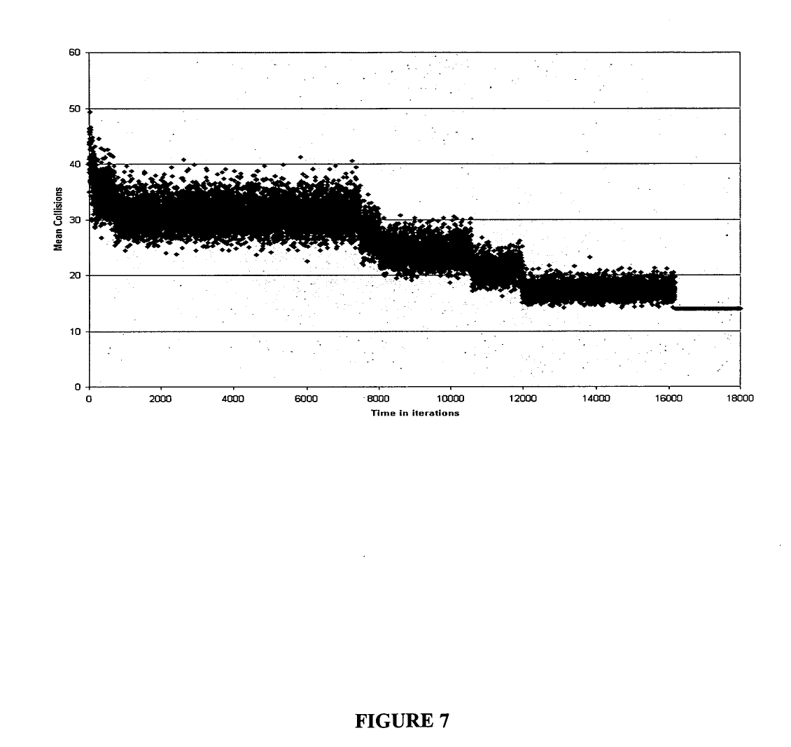

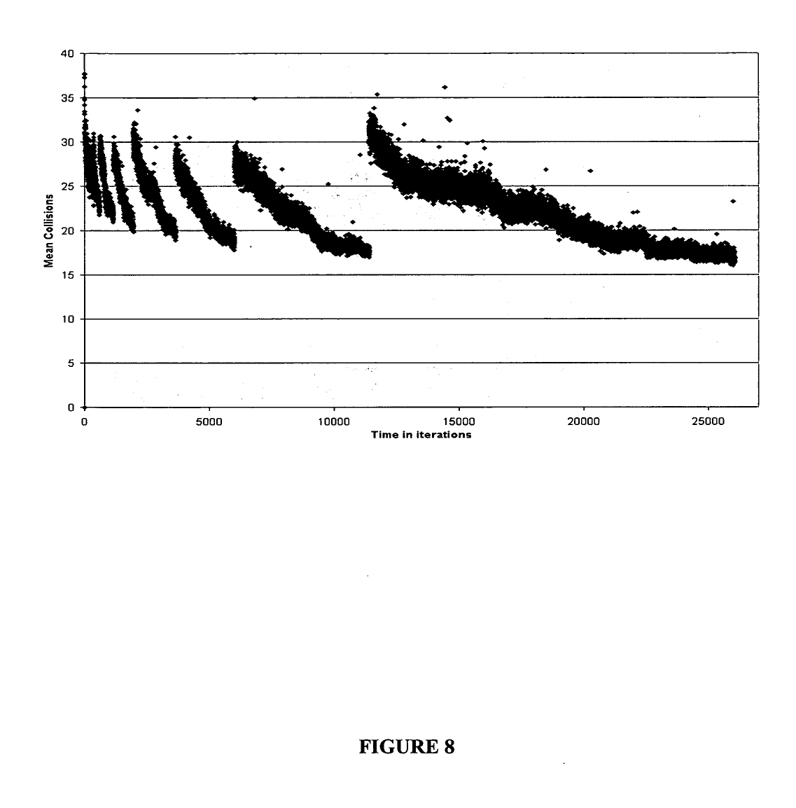

FIG. 7 shows a situation of punctuate equilibrium. FIG. 8 shows a situation in which the environmental conditions are varied at preset time periods by changing the data set. Note that the evolution continues to adapt the population to the new environmental conditions.

### Second Embodiment of the Invention

Another embodiment is to implement this method on a distributed system. In its current implementation, determination of efficiency requires that the data be hashed by each function under examination. Herein lies the greatest computational expense of this algorithm, and a distributed implementation would allow this burden to be spread over the entire network with minimal run-time data transfer—the only network usage would be the transfer of specific polynomial coefficients and the return of a collision number. Two metaphors for evolution over a distributed network present themselves. First is that of each client representing a single creature; the second is that of each computer as a distinct environment, each performing the evolution in parallel with minimal interaction of populations.

### CONCLUSION

We have demonstrated that evolutionary techniques are a powerful method that can yield excellent results when applied to hashing. This is the first time non-deterministic algorithms have been used to determine hash function free parameters. The non-standard method allows for fast convergence to optimal hashing functions. The advantage of our method is that most of the computation is done beforehand—a hashing function may be evolved to a particular data set, and then saved and reused continuously, as long as the data does not undergo drastic change. In the case of large changes to the data, the polynomial may be re-evolved to improve search efficiency.

The algorithm was successful in locating polynomials that operated efficiently as hashing functions. On average, hashing with these polynomials reduced the number of collisions by over fifty percent when compared to other common hashing methods. Although performance degraded with all hashing functions as density of the data increased, the evolved polynomials were more resilient to unfavorable conditions. This confirms that evolution successfully adapts polynomials to varied situations. Such results speak to the power of the evolutionary method in the field of hashing.

Reproduced in Table 9 are the header prototypes for the hash table class, as well as the seeder class, which were the two main classes used to test the evolutionary strategies. Work was done on a Intel-based 686 machine, using Microsoft Visual Studio for c++ compilation. Any c++ compiler that supports template classes can be used to compile the code.

It will be appreciated from the above that the invention may be implemented as computer software, which may be supplied on a storage medium or via a transmission medium as a network or the Internet.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

TABLE 9
Source code header files

/* Hash Table */
#include “apvector.h” // standard vector class
#include “hashFunc.h”
#include <fstream.h>
const int max_func = 5;
template <class itemType>
class hash
{
public:

hash( int userSize, itemType userEmpty, itemType
userRemoved );
hash( const hash& h );
hash operator=( const hash& h );
˜hash( );
void defHash( int (*func) ( int index, •n titer ) );

// sets the default hashing function

void mainHash( const hashFunc<itemType> func[ ] );

// sets the main hashing function array

void addHash( const hashFunc<itemType>& func );

// adds a new hashing function to end of array

void clearHash( );

// clears all hash functions

const apvector<itemType>& addData( const apvector<itemType>&
userData);

// hashs data in userData, and returns all items not
processed

int addDatum( const itemType& userDatum );

// adds a single data item to the hash table

int removeDatum( const itemType& userDatum );

// removes a single data item to the hash table

int seekDatum( const itemType& userDatum );

// returns true iff userDatum is in the hash table

void clearData( );

// clears hash table

void readData( char* filein, char* fileout );

// reads data from file, assumes itemType has >>
operator

void printData( char* fileout );

// prints data to file, assumes itemType has <<
operator

const apvector<itemType>& getData( ) const;

// returns the current state of the hash table

int testHash( const apvector<itemType>& userData );

// returns the number of collisions

private:

| | |
|---|---|
| apvector<itemType> data; | // hash table |

| | |
|---|---|
| hashFunc<itemType> hash_func[max_func]; | // hashing |
| | functions |

int (*def_hash) ( int index, •n titer );

// default hashing function

| | |
|---|---|
| int size; | // table size |
| itemType empty_val, | // default “empty” value |

removed_val; // value entered in slot after member is
removed

};
int linear( int index, •n titer );

// linear probing rehash strategy

int quadratic( int index, •n titer );

// quadratic rehash strategy

/* Seeder class */
#include “apstring.h” // standard string source
#include <fstream.h>
const char* seeder_config_file = “seeder.cfg”;
template <class seedType>
class Seeder
{
public:

Seeder( char* filename, long maxloc );
˜Seeder( );
seedType nextSeed( );

private:

ifstream rand;
long loc;
long max_loc;

};

I claim:

1. A method of data storage, used to store and retrieve data, the method comprising:
(i) creating an empty hash table;
(ii) generating a plurality of functions randomly;
(iii) hashing the data using each one of the plurality of functions;
(iv) recording a number of collisions for each one of the plurality of functions;
(v) ranking the plurality of functions based on the number of collisions;
(vi) saving the plurality functions within a first and a second range of collisions;
(vii) modifying the plurality of functions within said second range of collisions;
(viii) deleting the plurality functions within a third range of collisions;
(ix) generating new random functions equal to the number within said third range of collisions deleted in step (vii); and
(x) selecting a function with a lowest number of collisions as a hashing function for said hash table;
wherein said first range of collisions is lower than said second range of collisions; and
wherein said second range of collisions is lower than said third range of collisions.

2. The method of data storage according to claim 1, further comprising:
(a) selecting a target collision frequency and a maximum number of iterations; and
(b) repeating steps (ii) to (viii) until either said target collision frequency has been reached, or said maximum number of iterations has been exceeded.

3. The method of data storage according to claim 1, wherein step (vii) further comprises:
randomly mutating and said plurality of functions within said second range of collisions.

4. The method of data storage according to claim 1, wherein step (vii) further comprises:
pairing polynomials within said first and second range of collisions and using said periods as double hashing functions in said hash table.

5. The method of data storage according to claim 1, further comprising:
storing a data item by using said function selected in step (x) to hash said data item.

6. The method of data storage according to claim 1, further comprising:
(d) retrieving a data item by using said function selected in step (x) to hash said data item.

7. The method of data storage according to claim 1, further comprising:
testing for presence of a data item by using said function selected in step (x) to hash said data item.

8. The method of data storage according to claim 1,
wherein said plurality of hashing functions are polynomials.

9. The method of dat storage according to claim 1,
wherein said plurality of hashing functions are Fourier series.

10. A data storage apparatus for storing and retrieving data, comprising:
a hash table;
a hash function selected from a plurality of functions;
a random function generator to generate said plurality of functions;
hashing means to hash said data using each one of the plurality of functions;
recording means to record a number of collisions for each one of the plurality of functions;
ranking means to rank the plurality of functions based on the number of collisions recorded by the recording means;
storage means to store functions;
modification means to modify said plurality of functions; and
selection means to select a function from the plurality of functions with a lowest number of collisions,
wherein a plurality functions within a second range of collisions are modified,
wherein a plurality of functions within a third range of collisions are deleted and new random functions equal to the number deleted are randomly generated by the random function generator,
wherein said first range of collisions is lower than said second range of collisions, and
wherein said second range of collisions is lower than said third range of collisions.

11. The data storage apparatus according to claim 10, further comprising:
(a) selection means to select a target collision frequency and a maximum number of iterations; and
(b) logic means to repeat steps (ii) to (viii) until either said target collision frequency has been reached, or said maximum number of iterations has been exceeded.

12. The data storage apparatus according to claim 10,
wherein the modification means randomly mutates said plurality of functions within said second range of collisions.

13. The data storage apparatus according to claim 10,
wherein the modification means pairs polynomials within said first and second range of collisions and uses said pairs as double hashing functions in said hash table.

14. The data storage apparatus according to claim 10, further comprising:
data storage means for storing a data item by using said function selected by the selection means to hash said data item.

15. The data storage apparatus according to claim 10, further comprising:
data retrieval means for retrieving a data item by using said function selected by the selection means to hash said data item.

16. The data storage apparatus according to claim 10, further comprising:
data testing means for testing for presence of a data item by using said function selected by the selection means to hash said data item.

17. The data storage apparatus according to claim 1,
wherein said plurality of hashing functions are polynomials.

18. The data storage apparatus according to claim 10,
wherein said plurality of hashing functions are Fourier series.
